(19) United States
(12) Patent Application Publication
(10) Pub. No.: US 2015/0157016 A1
(43) Pub. Date: Jun. 11, 2015

(54) METHOD OF CONTROLLING WEEDS

(71) Applicant: SUMITOMO CHEMICAL COMPANY, LIMITED, Tokyo (JP)

(72) Inventor: Hajime IKEDA, Kasai-shi (JP)

(73) Assignee: SUMITOMO CHEMICAL COMPANY, LIMITED, Tokyo (JP)

(21) Appl. No.: 14/098,189

(22) Filed: Dec. 5, 2013

(51) Int. Cl. A01N 43/84

(52) U.S. Cl. CPC A01N 43/84

(57) ABSTRACT

The present invention relates to a method of controlling weeds in a crop fields, land under perennial crops, or a non-crop land, the method comprising applying an effective amount of crystal of flumioxazin which shows a powder X-Ray diffraction pattern having diffraction peaks with 2θ values (°) shown in Table 1, said pattern being obtained by CuKα rays diffraction analysis,

TABLE 1
2θ value (°)
9.8 ± 0.1
11.4 ± 0.1
12.7 ± 0.1
13.8 ± 0.1
16.0 ± 0.1
16.4 ± 0.1
16.7 ± 0.1

to soil where the weeds are grown or to be grown, or weeds.

According to the present invention, a wide range of weeds can be controlled in a crop field, land under perennial crops, or a non-crop land.

### BACKGROUND OF THE INVENTION

1. Field of the Invention

The present invention relates to a method of controlling weeds.

2. Description of the Related Art

Flumioxazin is known as an effective herbicide in order to control weeds.

### PRIOR ART LITERATURE

### Non-Patent Literatures

Non-Patent Literature 1: Crop Protection Handbook, vol. 97 (2011) Meister Publishing Company, ISBN: 1-892829-23-1)

### SUMMARY OF THE INVENTION

It is an object of the present invention to provide a method of controlling weeds having high herbicidal effect.

The inventor of the present invention have made earnest studies to find a method of controlling weeds having high herbicidal effect and, as a result, found that flumioxazin constituted of a crystal having a specific crystal form exhibits high herbicidal effect against weeds. This finding has led to completion of the present invention.

The present invention is as follows.

[1]A method of controlling weeds in a crop field, land under perennial crops, or non-crop land, the method comprising applying an effective amount of crystal of flumioxazin which shows a powder X-Ray diffraction pattern having diffraction peaks with 2θ values (0) shown in Table 1,

said pattern being obtained by CuKα rays diffraction analysis,

TABLE 1
2θ value (°)
9.8 ± 0.1
11.4 ± 0.1
12.7 ± 0.1
13.8 ± 0.1
16.0 ± 0.1
16.4 ± 0.1
16.7 ± 0.1

to soil where the weeds are grown or to be grown, or weeds.

[2] The method according to [1], wherein the crop field is a field for soybean, peanut, common bean, pea, corn, cotton, wheat, rice, sunflower, potato, sugar cane, or vegetable.

A wide range of weeds can be controlled by the method of controlling weeds of the present invention.

### DETAILED DESCRIPTION OF THE PREFERRED EMBODIMENTS

A method of controlling weeds of the present invention (hereinafter referred to as the method of the present invention” includes applying an effective amount of crystal of flumioxazin which shows a powder X-Ray diffraction pattern having diffraction peaks with 2θ values (°) shown in Table 1 above (hereinafter referred to as A-type crystal flumioxazin) to soil where weeds are grown or to be grown, or weeds in a crop field, land under perennial crops, or non-crop land.

The A-type crystal flumioxazin used in the method of the present invention may be prepared by the methods described in Examples and modified methods thereof. A flumioxazin solution or suspension may be used as a starting material to produce the A-type crystal flumioxazin. Also, a solution or suspension of a synthetic reaction crude product containing flumioxazin may be used. A seed crystal may be added in the crystallization and in this case, it is preferable to use a crystal with the crystal form to be prepared. The amount of the seed crystals to be added is preferably 0.0005 parts by weight to 0.02 parts by weight, and more preferably 0.001 parts by weight to 0.01 parts by weight based on 1 part by weight of flumioxazin.

The A-type crystal flumioxazin may be isolated, for example, by filtration, centrifugation, or gradient method. This A-type crystal flumioxazin may be washed with a proper solvent according to the need. Also, the obtained A-type crystal flumioxazin can be improved in purity and quality by recrystallization or slurry purification. Crystals of a solvate may be converted into crystals of a non-solvate by drying with heating under reduced pressure. The degree of dryness of the crystal may be determined by analytical means such as gas chromatography. Also, the polymorph form purity of the crystal may be determined by subjecting the crystal to powder X-ray diffraction measurement to analyze the presence or absence and height of a diffraction peak specific to the solvate crystal. The A-type crystal flumioxazin is a solvate or non-solvate. When a specific hydrophilic organic solvent is used as a solvent for crystallization, there is the case where the A-type crystal flumioxazin forms a solvate. Anon-solvate is obtained by drying the solvate with heating under reduced pressure.

The method of controlling weeds of the present invention (hereinafter referred to as the method of the present invention) can be attained by applying the A-type crystal flumioxazin to soil where weeds are grown or to be grown, or weeds.

A wide range of weeds in a crop field, land under perennial crops, or non-crop land where usual tillage cultivation or non-tillage cultivation is carried out, can be controlled by the method of controlling weeds of the present invention.

Examples of the crop field in the present invention include fields for food crops such as soybean, corn, cotton, wheat, barley, rye, triticale, rice, peanut, common bean, lima bean, azuki bean, cowpeas, mung bean, black lentil, scarlet runner bean, vigna umbellate, moth bean, tepary bean, broad bean, pea, garbanzo bean, lentil, lupine, pigeon pea, and potato; forage crops such as sorghum, oat, and alfalfa; industrial crops such as sugar beet, sunflower, rapeseed, and sugar cane; and garden crops including vegetables. Examples of the vegetables to which the present invention is applied include Solanaceae vegetables (for example, eggplant, tomato, green pepper, bell pepper, and hot pepper); Cucurbitaceae vegetables (for example, cucumber, pumpkin, zucchini, watermelon, and melon); Cruciferous vegetables (for example, Japanese radish, turnip, horseradish, kohlrabi, Chinese cabbage, cabbage, brown mustard, broccoli, and cauliflower); Compositae vegetables (for example, burdock, garland chrysanthemum, artichoke, and lettuce); Liliaceae vegetables (for example, Welsh onion, onion, garlic, asparagus); Umbelliferae vegetables (carrot, parsley, celery, and parsnip); Chenopodiaceae vegetables (for example, spinach and Swiss chard); Labiatae vegetables (for example, Japanese mint, mint, basil, and lavender); strawberry; sweet potato; yam; and aroid.

Also, the crop fields in the present invention include fields for cultivating so-called biomass crops such as Jatropha curcas, switchgrass, Miscanthus, Arundo, reed canarygrass, bluestem, Erianthus, napier grass, and Spartina, used to produce oil and fats or alcohols for fuels used in heat engines.

The method of the present invention is particularly applied as a method efficiently controlling weeds in fields for cultivating soybean, peanut, common bean, pea, corn, cotton, wheat, rice, sunflower, potato, sugar cane, or vegetables among the above crop fields.

When the method of the present invention is applied to a field for sugar cane, stem fragments cut so as to have one stalk may be used as the stem fragment of sugar cane, or stem fragments having a size of 2 cm to 15 cm may be used in the cultivation of sugar cane. Sugar cane cultivation methods using such stem fragments are publicly known (WO09/000398, WO09/000399, WO09/000400, WO09/000401, and WO09/000402) and carried out under the brand name of Plene (trademark).

Examples of the land under perennial crops in the present invention include orchards, tea gardens, mulberry gardens, coffee plantations, banana gardens, coconut gardens, flower/tree gardens, flower/tree fields, seeding fields, breeding farms, woodlands, and garden parks. Examples of fruit trees in the present invention include kernel fruits (for example, apples, European pears, Japanese pears, Chinese quince, and Quinces), stone fruits (for example, peaches, plums, nectarines, Japanese apricots, cherries, apricots, and prunes), citruses (Citrus unshiu, oranges, lemons, limes, and grapefruits), nut trees (for example, Japanese chest nuts, walnuts, hazel nuts, almonds, pistachios, cashew nuts, and macadamia nuts), berry fruits (for example, blueberries, cranberries, blackberries, and raspberries), grapes, permissions, olives, and loquats.

The method of the present invention is applied as a method of efficiently controlling weeds, particularly, in orchards.

Examples of the non-crop land include playgrounds, vacant lands, railroad sides, parks, car parks, roadsides, river beds, areas under power cables, housing sites, and sites for factories.

In the present invention, any type of crop may be used as the crops cultivated in crop field without any particular limitation insofar as it is a variety usually cultivated as crops.

This variety of plants includes plants to which resistance to protoporphyrinogen IX oxidase inhibitors such as flumioxazin; 4-hydroxyphenylpyrubic acid dioxygenase inhibitors such as isoxaflutole; acetolactate synthase inhibitors such as imazethapyr and thifensulfuron-methyl; acetyl-CoA carboxylase inhibitors such as sethoxydim; 5-enolpyruvylshikimate-3-phosphoric acid synthase inhibitors such as glyphosate; glutamine synthetase inhibitors such as glufosinate; auxin type herbicides such as 2,4-D and dicamba; and herbicides such as bromoxinyl are imparted by classical breeding methods or genetic modification technologies.

As examples of crops to which resistance has been imparted by classical breeding methods, corn resistant to imidazolinone type acetolactate synthase inhibitory herbicides such as imazethapyr is given and has already been commercially available under the trade name of Clearfield (trademark). Examples of such crops include STS soybeans resistant to sulfonylurea type acetolactate synthase inhibitory herbicides such as thifensulfuron-methyl. Similarly, examples of a plant to which resistance to an acetyl CoA carboxylase inhibitor such as trione oxime-based or aryloxyphenoxypropionic acid-based herbicide has been imparted by classical breeding methods include SR corn.

Examples of a plant to which resistance has been imparted by genetic modification technologies include corn, soybeans and cotton resistant to glyphosate, and they have already been commercially available under the trade names of RoundupReady (registered trade mark), Agrisure (registered trademark) GT, Gly-Tol (registered trademark) and the like. Similarly, there are corn, soybeans and cotton resistant to glufosinate by genetic modification technologies, and they have already been commercially available under the trade names of LibertyLink (registered trademark) and the like. There are varieties of corn and soybeans under the trade names of Optimum (registered trademark) and GAT (registered trade mark), which are resistant to both of glyphosate and ALS inhibitor. Similarly, there are soybeans resistant to imidazolinone type acetolactate synthase inhibitors by genetic modification technologies, and they have been developed under the name of Cultivance. Similarly, there is cotton resistant to bromoxynil by genetic modification technologies, and this has already been commercially available under the trade name of BXN (registered trademark). Similarly, there is a variety of soybean sold under the trade name of RoundupReady (registered trademark) 2 Xtend as a soybean resistant to both of glyphosate and dicamba by genetic modification technologies. Similarly, there has been developed cotton resistant to both of glyphosate and dicamba by genetic modification technologies.

A gene encoding aryloxyalkanoate dioxygenase may be introduced to produce a crop which becomes resistant to phenoxy acid type herbicides such as 2,4-D, MCPA, dichlorprop and mecoprop, and aryloxyphenoxypropionic acid type herbicides such as quizalofop, haloxyfop, fluazifop, diclofop, fenoxaprop, metamifop, cyhalofop and clodinafop (Wright et al. 2010: Proceedings of National Academy of Science. 107 (47): 20240-20245). Cultivars of soybean and cotton, which show the resistance to 2,4-D, have been developed under the brand of Enlist.

A gene encoding a 4-hydroxyphenyl pyruvic acid dioxygenase (hereinafter referred to as HPPD) inhibitor, the gene having resistance to HPPD, may be introduced to create a plant resistant to a HPPD inhibitor (US2004/0058427). A gene capable of synthesizing homogentisic acid which is a product of HPPD in a separate metabolic pathway even if HPPD is inhibited by a HPPD inhibitor is introduced, with the result that a plant having resistance to the HPPD inhibitor can be created (WO02/036787). A gene expressing excess HPPD may be introduced to produce HPPD in such an amount as not to adversely affect the growth of plants even in the presence of a HPPD inhibitor, with the result that a plant having resistance to the HPPD inhibitor can be created (WO96/38567). Besides introduction of the gene expressing excess HPPD, a gene encoding prephenate dehydrogenase is introduced in order to increase the yield of p-hydroxyphenyl pyruvic acid which is a substrate of HPPD to create a plant having resistance to the HPPD inhibitor (Rippert P et. al., 2004 Engineering plant shikimate pathway for production of tocotrienol and improving herbicide resistance. Plant Physiol. 134: 92-100).

Examples of a method of producing crops resistant to herbicides include, other than the above, the gene introducing methods described in WO98/20144, WO2002/46387, and US2005/0246800.

The above crops include, for example, crops which can synthesize selective toxins and the like known as the genus Bacillus by using genetic modification technologies.

Examples of the toxins developed in such genetically modified plants include insecticidal proteins derived from Bacillus cereus and Bacillus popilliae; 6-endotoxins such as Cry1Ab, Cry1Ac, Cry1F, Cry1Fa2, Cry2Ab, Cry3A, Cry3Bb1, Cry9C, Cry34, and Cry35ab derived from Bacillus thuringiensis; insecticidal proteins such as VIP1, VIP2, VIP3, and VIP3A; insecticidal proteins derived from nematodes; toxins produced by animals such as scorpion toxins, spider toxins, bee toxins, and neurotoxins specific to insects; filamentous fungus toxins; plant lectins; agglutinin; trypsin inhibitors, serine protease inhibitors, and protease inhibitors such as patatin, cystatin, and papain inhibitors; ribosome inactivating proteins (RIP) such as lysine, corn-RIP, abrin, lufin, saporin, and bryodin; steroid metabolic enzymes such as 3-hydroxysteroid oxidase, ecdysteroid-UDP-glucosyltransferase, and cholesterol oxidase; ecdysone inhibitors; HMG-CoA reductase; ion channel inhibitors such as sodium channel and calcium channel inhibitors; juvenile hormone esterase; diuretic hormone receptors; stilbene synthase; bibenzyl synthase; chitinase; and glucanase.

The toxins expressed in these transgenic plants include hybrid toxins, partially deficient toxins and modified toxins, which derive from 6-endotoxin proteins such as Cry1Ab, Cry1Ac, Cry1F, Cry1Fa2, Cry2Ab, Cry3A, Cry3Bb1, Cry9C, Cry34Ab and Cry35Ab, and insecticidal proteins such as VIP1, VIP2, VIP3 and VIP3A. The hybrid toxins are created by new combinations of domains having different proteins by using genetic modification technologies. As the partially defective toxins, Cry1Ab in which part of the amino acid sequences is missing is known. In the modified toxin, one or more of amino acids of a natural type toxin is replaced. Examples of these toxins and genetically modified plants capable of synthesizing these toxins are described in, for example, EP-A-0374753, WO 93/07278, WO95/34656, EP-A-0427529, EP-A-451878, and WO 03/052073. Resistance to noxious insects belonging to order Coleoptera, order Diptera, and order Lepidoptera is imparted to plants by toxins contained in these genetically modified plants.

Also, genetically modified plants which contain one or more insecticidal genes resistant to harmful insects and develop one or more toxins have been already known and some of these plants have been put on the market. Examples of these genetically modified plants include YieldGard (registered trademark) (corn variety expressing Cry1Ab toxin), YieldGard Rootworm (registered trademark) (corn variety expressing Cry3Bb1 toxin), YieldGard Plus (registered trademark) (corn variety expressing Cry1Ab and Cry3Bb1 toxins), Herculex I (registered trademark) (corn variety expressing phosphinothricin N-acetyltransferase (PAT) for imparting resistance to a Cry1Fa2 toxin and glufosinate), NatureGard (registered trademark), AGRISURE (registered trademark) CBAdvantage (Bt11 cornborer (CB) trait), Protecta (registered trademark); and the like.

Also, genetically modified cotton which contains one or more insecticidal genes resistant to harmful insects and develops one or more toxins has been already known and some of cotton have been put on the market. Examples of these genetically modified cotton include BollGard (registered trademark) (cotton variety expressing Cry1Ac toxin), BollGard (registered trademark) II (cotton variety expressing Cry1Ac and Cry2Ab toxins), BollGard (registered trademark) III (cotton variety expressing Cry1Ac, Cry2Ab and VIP3A toxins), VipCot (registered trademark) (cotton variety expressing VIP3A and Cry1Ab toxins), WideStrike (registered trademark) (cotton variety expressing Cry1Ac and Cry1F toxins) and the like.

Examples of the plant used in the present invention also include plants such as soybeans into which a Rag1 (Resistance Aphid Gene 1) gene is introduced to impart resistance to an aphid.

The plants to be used in the present invention include those provided with resistance to nematodes by using a classical breeding method or genetic modification technologies. Examples of the genetic modification technologies used to provide the resistance to nematodes include RNAi.

The above crops include those to which the ability to produce antipathogenic substances having a selective effect is imparted using genetic modification technologies. For example, PR proteins are known as an example of the antipathogenic substance (PRPs, EP-A-0392225). Such antipathogenic substances and genetically modified plants producing these antipathogenic substances are described in, for example, EP-A-0392225, WO 95/33818, and EP-A-0353191. Examples of the antipathogenic substances developed in such genetically modified plants include ion channel inhibitors such as a sodium channel inhibitor and calcium channel inhibitor (KP1, KP4, and KP6 toxins produced by virus are known); stilbene synthase; bibenzyl synthase; chitinase; glucanase; PR protein; antipathogenic substances produced by microorganisms such as peptide antibiotics, antibiotics having a heteroring, and a protein factor (referred to as a plant disease resistant gene and described in WO 03/000906) relating to plant disease resistance.

The above crops include plants to which useful traits such as an oil component reformation and amino acid-content reinforcing trait are given by genetic modification technologies. Examples of these plants include VISTIVE (trademark) (low linolenic soybean having a reduced linolenic content), high-lysine (high oil) corn (corn having an increased lysine or oil content) and the like.

Moreover, the above crops include stuck varieties obtained by combining two or more useful traits such as the above classical herbicide trait or herbicide resistant gene, gene resistant to insecticidal noxious insects, antipathogenic substance-producing gene, oil component reformation, and amino acid-content reinforcing trait, and allergen reduction trait.

As the weeds which can be controlled by the method of the present invention, the following examples are given.

Weeds of the family Urticaceae: Urtica urens;

weeds of the family Polygonaceae: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicas, Rumex crispus, Rumex obtusifolius, and Rumex acetosa;

weeds of the family Portulacaceae: Portulaca oleracea;

weeds of the family Caryophyllaceae: Stellaria media, Cerastium holosteoides, Cerastium glomeratum, Spergula arvensis, and Silene gallica;

weeds of the family Molluginaceae: Mollugo verticillata;

weeds of the family Chenopodiaceae: Chenopodium album, Chenopodium ambrosioides, Kochia scoparia, Salsola kali, and Atriplex spp.;

weeds of the family Amaranthaceae: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, and Alternanthera tenella;

weeds of the family Papaveraceae: Papaver rhoeas and Argemone mexicana;

weeds of the family Brassicaceae: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, and Coronopus didymus;

weeds of the family Capparaceae: Cleome affinis;

weeds of the family Fabaceae: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsute, Indigofera truxillensis, and Vigna sinensis;

weeds of the family Oxalidaceae: Oxalis corniculata, Oxalis strica, and Oxalis oxyptera;

weeds of the family Geraniaceae: Geranium carolinense and Erodium cicutarium;

weeds of the family Euphorbiaceae: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, and Ricinus communis;

weeds of the family Malvaceae: Abutilon theophrasti, Sida rhombiforia, Sidacordifolia, Sida spinosa, Sidaglaziovii, Sida santaremnensis, Hibiscus trionum, Anoda cristata, and Malvastrum coromandelianum;

weeds of the family Sterculiaceae: Waltheria indica;

weeds of the family Violaceae: Viola arvensis, and Viola tricolor;

weeds of the family Cucurbitaceae: Sicyos angulatus, Echinocystis lobata, and Momordica charantia;

weeds of the family Lythraceae: Lythrum salicaria;

weeds of the family Apiaceae: Hydrocotyle sibthorpioides;

weeds of the family Sapindaceae: Cardiospermum halicacabum;

weeds of the family Primulaceae: Anagallis arvensis;

weeds of the family Asclepiadaceae: Asclepias syriaca and Ampelamus albidus;

weeds of the family Rubiaceae: Galium aparine, Galium spurium var. echinospermon, Spermacoce latifolia, Richardia brasiliensis, and Borreria alata;

weeds of the family Convolvulaceae: Ipomoea nil, Ipomoea hederacea, Ipomoea purpurea, Ipomoea hederacea var. integriuscula, Ipomoea lacunose, Ipomoea triloba, Ipomoea acuminate, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoids, and Jacquemontia tamnifolia;

weeds of the family Boraginaceae: Myosotis arvensis;

weeds of the family Lamiaceae: Lamium purpureum, Lamium amplexicaule, Leonotis nepetaefolia, Hyptis suaveolens, Hyptis lophanta, Leonurus sibiricus, and Stachys arvensis;

weeds of the family Solanaceae: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, and Nicandra physaloides;

weeds of the family Scrophulariaceae: Veronica hederaefolia, Veronica persica, and Veronica arvensis;

weeds of the family Plantaginaceae: Plantago asiatica;

weeds of the family Asteraceae: Xanthium pensylvanicum, Xanthium occidentale, Helianthus annuus, Matricaria chamomilla, Matricaria perforate, Chrysanthemum segetum, Matricaria matricarioides, Artemisia princeps, Artemisia vulgaris, Artemisia verlotorum, Solidago altissima, Taraxacum officinale, Galinsoga ciliate, Galinsoga parviflora, Senecio vulgaris, Senecio brasiliensis, Senecio grisebachii, Conyza bonariensis, Conyza Canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, and Soliva sessilis;

weeds of the family Liliaceae: Allium canadense and Allium vineale;

weeds of the family Commelinaceae: Commelina communis, Commelina bengharensis, and Commelina erecta;

weeds of the family Poaceae: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, and Rottboellia cochinchinensis;

weeds of the family Cyperaceae: Cyperus microiria, Cyperus iria, Cyperus odoratus, Cyperus rotundus, Cyperus esculentus, and Kyllinga gracillima; and

weeds of the family Equisetaceae: Equisetum arvense and Equisetum palustre.

In the method of the present invention, the A-type crystal flumioxazin is usually mixed with a solid carrier, liquid carrier, or the like and, according to the need, formulated with surfactants and other preparation aids into preparations such as an emulsion, water-dispersible powder, suspension, and granule. These preparations each contain the A-type crystal flumioxazin in an amount of usually 0.05 to 90% by weight and preferably 0.1 to 80% by weight.

In the method of the present invention, examples of the solid carrier used for formulating the A-type crystal flumioxazin into preparations include microparticles and granules of compounds such as clays (for example, Kaolinite, diatomaceous earth, synthetic water-containing silicon oxide, Fubasami clay, bentonite, and acid clay), talc, other inorganic minerals (for example, sericite, quartz powder, sulfur powder, activated carbon, and calcium carbonate), and chemical fertilizers (ammonium sulfate, ammonium phosphate, ammonium nitrate, ammonium chloride, and urea), and examples of the liquid carrier include water, alcohols (for example, methanol and ethanol), ketones (for example, acetone, methyl ethyl ketone, and cyclohexanone), aromatic hydrocarbons (for example, toluene, xylene, ethylbenzene, and methylnaphthalene), non-aromatic hydrocarbons (hexane, cyclohexane, and kerosene), esters (for example, ethyl acetate and butyl acetate), nitriles (for example, acetonitrile and isobutyronitrile), ethers (for example, dioxane and diisopropyl ether), acid amides (for example, dimethylformamide and dimethylacetamide), and halogenated hydrocarbons (for example, dichloroethane and trichloroethylene).

In the method of the present invention, examples of the surfactant used for formulating the A-type crystal flumioxazin into preparations include alkyl sulfates, alkyl sulfonates, alkylaryl sulfonates, alkyl aryl ethers and polyoxyethylene products thereof, polyethylene glycol ethers, polyhydric alcohol esters, and sugar alcohol derivatives. Examples of the other preparation aids include binders and dispersants such as casein, gelatin, polysaccharides (for example, starch, gum arabic, cellulose derivatives, and alginic acid), lignin derivatives, bentonite, synthetic water-soluble polymers (for example, polyvinyl alcohol, polyvinyl pyrrolidone, and polyacrylic acids), and stabilizers such as PAP (acidic isopropyl phosphate), BHT (2,6-tert-butyl-4-methylphenol), BHA (2-/3-tert-butyl-4-methoxyphenol), vegetable oil, mineral oil, fatty acid, and fatty acid ester.

The A-type crystal flumioxazin formulated into a preparation in this manner may be sprayed on soil or plant body either as it is, or after it is made into a dilute solution by diluting it with water or the like. In the method of the present invention, other herbicides are further mixed with the A-type crystal flumioxazin for use, so that an increase in herbicidal effect is expected. Also, the A-type crystal flumioxazin may be further used together with, for example, insecticides, germicides, plant growth regulators, fertilizers, and soil conditioners.

The amount of the A-type crystal flumioxazin to be used in the method of the present invention is usually 2 to 10000 g, preferably 5 to 5000 g in terms of compound amount/ha though this differs depending on weather conditions, preparation form, time of use, method of use, place of use, weeds to be controlled, and object crop. When the A-type crystal flumioxazin is used in the form of emulsion, water-dispersible powder, suspension, or the like, a specified amount of the emulsion, water-dispersible powder, suspension, or the like is usually diluted with 100 to 2000 L/ha for use. Also, when the A-type crystal flumioxazin is used to perform stem leaves treatment of weeds, adjuvants are added to the dilute solution of the A-type crystal flumioxazin in order to increase the herbicidal effect against weeds.

In the method of the present invention, weeds or places where weeds are expected to grow are treated with the A-type crystal flumioxazin. Examples of the treatment of weeds include treatment of weeds themselves and treatment of soil after weeds grow. The treatment of the place where weeds are expected to grow includes treatment of the surface of soil before weeds grow.

The following aspects are given as examples of the treatment method in the method of the present invention:

a method in which the flumioxazin solution is sprayed on the surface of soil before crops are sowed and before weeds grow;

a method in which the flumioxazin solution is sprayed on the surface of soil before crops are sowed and after weeds grow;

a method in which the flumioxazin solution is sprayed on weeds before crops are sowed and after the weeds grow;

a method in which the flumioxazin solution is sprayed on the surface of soil after crops are sowed but before they germinate, and before weeds grow;

a method in which the flumioxazin solution is sprayed on the surface of soil after crops are sowed but before they germinate, and after weeds grow;

a method in which the flumioxazin solution is sprayed on weeds after crops are sowed but before they germinate, and after the weeds grow;

a method in which the flumioxazin solution is sprayed on the surface of soil in the presence of crops before germination of weeds;

a method in which the flumioxazin solution is sprayed on the surface of soil in the presence of crops after weeds grow; and/or

a method in which the flumioxazin solution is sprayed on the surface of soil in the presence of crops after germination of the weeds.

### EXAMPLES

Hereinbelow, the present invention will be described in detail by way of examples, but the present invention is not limited to these examples.

### Production Example

Production Examples of A-type crystal flumioxazin used in the method of the present invention will be shown below.

### Example 1

Flumioxazin (100 mg) was dissolved in methylisobutylketone at 60° C. so as to adjust its concentration to 10.1 mg/mL. The solvent was rapidly cooled to 0° C., followed by being left to stand to obtain A-type crystals.

By X'Pert Pro MPD (manufactured by Nederland PANalytical B.V.), a powder X-ray diffraction pattern of the obtained crystals was measured for each crystal at a scanning range from 2.0° to 40.0° (2θ) using CuKα rays (40 kV, 30 mA).

The pattern of the obtained crystals had the peaks with as 2θ values as shown in Table 2.

TABLE 2

| 2θ value (°) | d value (Å) | Relative intensity (%) |
|---|---|---|
| 9.8 | 9.0179 | 61.1 |
| 11.4 | 7.7556 | 13.1 |
| 12.7 | 6.9645 | 100.0 |
| 13.8 | 6.4117 | 24.1 |
| 16.0 | 5.5347 | 37.9 |
| 16.4 | 5.4006 | 32.4 |
| 16.7 | 5.3042 | 29.1 |

### Preparation Examples

Preparation Examples will be shown below. Here, the parts represent parts by weight.

### Preparation Example 1

A-type crystal flumioxazin (10 parts), polyoxyethylene sorbitan monooleate (3 parts), CMC (carboxymethyl cellulose) (3 parts), and water (84 parts) are mixed with one another and the mixture is wet-milled to the extent that it has a grain size of 5 micrometer or less to obtain a suspension.

### Preparation Example 2

A-type crystal flumioxazin (1 part), polyoxyethylene sterylphenyl ether (14 parts), calcium dodecylbenzenesulfonate (6 parts), xylene (30 parts), and N,N-dimethylformamide (49 parts) are mixed with one another to obtain an emulsion.

### Preparation Example 3

A-type crystal flumioxazin (10 parts), sodium laurylsulfate (2 parts), and synthetic water-containing silicon oxide (88 parts) are mixed with one another to obtain a water-dispersible powder.

### Test Examples

In Test Examples, the herbicidal effect is evaluated as follows.

### [Herbicidal Effect]

In the evaluation of the herbicidal effect, the germination or growth condition of each test weed in a treated area is compared with that in an untreated area and when there is no or almost no difference in germination or growth condition between the treated area and the untreated area at the time of investigation, the case is given “0”, and when the test plant perfectly withers and dies, or the germination or growth of the plant is perfectly restricted at the time of investigation, the case is given “100”, thereby grading each sample between 0 to 100.

### Test Example 1

A pot is filled with soil and weeds are sowed, and the surface of the soil is uniformly treated with A-type crystal flumioxazin at a dose of 25, 50, 100, or 200 g/ha. After 15 days, cotton seeds are sowed. This pot is placed in a greenhouse. The herbicidal effect of the A-type crystal flumioxazin is examined 15 days after the cotton seeds are sowed.

### Test Example 2

Cotton seeds are sowed in a cultivated field. Weed stem and leaves are directly treated with A-type crystal flumioxazin at a dose of 25, 50, 100, 200, or 400 g/ha in the condition of the cotton main stem being lignified at a length of 15 cm from the surface of the ground 30 days after these seeds are sowed. The herbicidal effect is examined 28 days after the treatment.

### Test Example 3

A pot is filled with soil and weeds are sowed, and the surface of the soil is uniformly treated with A-type crystal flumioxazin at a dose of 25, 50, 100, or 200 g/ha. After 7 days, soybean seeds are sowed. This pot is placed in a greenhouse. The herbicidal effect of the A-type crystal flumioxazin is examined 15 days after the soybean seeds are sowed.

### Test Example 4

A pot is filled with soil and soybean seeds and weed seeds are sowed. On the day of sowing, the surface of the soil is uniformly treated with A-type crystal flumioxazin at a dose of 25, 50, 100, or 200 g/ha. This pot is placed in a greenhouse. The herbicidal effect of the A-type crystal flumioxazin is examined 15 days after the seeds are sowed.

### Test Example 5

A pot is filled with soil and weeds are sowed, and the surface of the soil is uniformly treated with A-type crystal flumioxazin at a dose of 25, 50, 100, or 200 g/ha. After 7 days, corn seeds are sowed. This pot is placed in a greenhouse. The herbicidal effect of the A-type crystal flumioxazin is examined 15 days after the corn seeds are sowed.

### Test Example 6

A pot is filled with soil and corn seeds and weed seeds are sowed. On the day of sowing, the surface of the soil is uniformly treated with A-type crystal flumioxazin at a dose of 25, 50, 100, or 200 g/ha. This pot is placed in a greenhouse. The herbicidal effect of the A-type crystal flumioxazin is examined 15 days after the seeds are sowed.

### Test Example 7

A pot is filled with soil and weeds are sowed, and the surface of the soil is uniformly treated with A-type crystal flumioxazin at a dose of 25, 50, 100, or 200 g/ha. After 15 days, wheat seeds are sowed. This pot is placed in a greenhouse. The herbicidal effect of the A-type crystal flumioxazin is examined 15 days after the wheat seeds are sowed.

### Test Example 8

A pot is filled with soil and weeds are sowed, and the surface of the soil is uniformly treated with A-type crystal flumioxazin at a dose of 25, 50, 100, or 200 g/ha. After 15 days, tomato seeds are sowed. This pot is placed in a greenhouse. The herbicidal effect of the A-type crystal flumioxazin is examined 15 days after the tomato seeds are sowed.

### Test Example 9

A pot is filled with soil and weeds are sowed, and the surface of the soil is uniformly treated with A-type crystal flumioxazin at a dose of 25, 50, 100, or 200 g/ha. After 15 days, eggplant seeds are sowed. This pot is placed in a greenhouse. The herbicidal effect of the A-type crystal flumioxazin is examined 15 days after the eggplant seeds are sowed.

### Test Example 10

A pot is filled with soil and weeds are sowed, and the surface of the soil is uniformly treated with A-type crystal flumioxazin at a dose of 25, 50, 100, or 200 g/ha. After 15 days, bell pepper seeds are sowed. This pot is placed in a greenhouse. The herbicidal effect of the A-type crystal flumioxazin is examined 15 days after the bell pepper seeds are sowed.

### Test Example 11

A pot is filled with soil and weeds are sowed, and the surface of the soil is uniformly treated with A-type crystal flumioxazin at a dose of 25, 50, 100, 200, or 400 g/ha. After 15 days, sugar cane stem fragments are planted. This pot is placed in a greenhouse. The herbicidal effect of the A-type crystal flumioxazin is examined 15 days after the sugar cane stem fragments are planted.

### Test Example 12

A pot is filled with soil and weeds are sowed, and the surface of the soil is uniformly treated with A-type crystal flumioxazin at a dose of 25, 50, 100, or 200 g/ha. After 15 days, common bean seeds are sowed. This pot is placed in a greenhouse. The herbicidal effect of the A-type crystal flumioxazin is examined 15 days after the common bean seeds are sowed.

### Test Example 13

A pot is filled with soil and weeds are sowed, and the surface of the soil is uniformly treated with A-type crystal flumioxazin at a dose of 25, 50, 100, or 200 g/ha. After 15 days, rice seeds are sowed. This pot is placed in a greenhouse. The herbicidal effect of the A-type crystal flumioxazin is examined 15 days after the rice seeds are sowed.

### Test Example 14

A pot is filled with soil and weeds are sowed, and the surface of the soil is uniformly treated with A-type crystal flumioxazin at a dose of 25, 50, 100, or 200 g/ha. After 15 days, rapeseeds are sowed. This pot is placed in a greenhouse. The herbicidal effect of the A-type crystal flumioxazin is examined 15 days after the rapeseeds are sowed.

### Test Example 15

Sugarcane stem fragments are sowed in a cultivated field. After the stem fragments are planted, the stem leaves of weeds are treated directly with A-type crystal flumioxazin at a dose of 25, 50, 100, 200, or 400 g/ha when the plant height of the sugarcane becomes 60 cm or higher. The herbicidal effect is examined 28 days after the treatment.

### Test Example 16

A pot is filled with soil and peanut seeds and weed seeds are sowed. On the day of sowing, the surface of the soil is uniformly treated with A-type crystal flumioxazin at a dose of 25, 50, 100, or 200 g/ha. This pot is placed in a greenhouse. The herbicidal effect of the A-type crystal flumioxazin is examined 15 days after the seeds are sowed.

### Test Example 17

A pot is filled with soil and common bean seeds and weed seeds are sowed. On the day of sowing, the surface of the soil is uniformly treated with A-type crystal flumioxazin at a dose of 25, 50, 100, or 200 g/ha. This pot is placed in a greenhouse. The herbicidal effect of the A-type crystal flumioxazin is examined 15 days after the seeds are sowed.

### Test Example 18

A pot is filled with soil and pea seeds and weed seeds are sowed. On the day of sowing, the surface of the soil is uniformly treated with A-type crystal flumioxazin at a dose of 25, 50, 100, or 200 g/ha. This pot is placed in a greenhouse. The herbicidal effect of the A-type crystal flumioxazin is examined 15 days after the seeds are sowed.

### Test Example 19

A pot is filled with soil and sunflower seeds and weed seeds are sowed. On the day of sowing, the surface of the soil is uniformly treated with A-type crystal flumioxazin at a dose of 25, 50, 100, or 200 g/ha. This pot is placed in a greenhouse. The herbicidal effect of the A-type crystal flumioxazin is examined 15 days after the seeds are sowed.

### Test Example 20

A pot is filled with soil, and weed seeds are sowed and sugarcane stem fragments are planted. On the day of sowing and planting, the surface of the soil is uniformly treated with A-type crystal flumioxazin at a dose of 25, 50, 100, 200, or 400 g/ha. This pot is placed in a greenhouse. The herbicidal effect is examined 15 days after the sowing and planting.

### Test Example 21

A pot is filled with soil, and weed seeds are sowed and potato tubers are planted. On the day of sowing and planting, the surface of the soil is uniformly treated with A-type crystal flumioxazin at a dose of 12.5, 25, 50, or 100 g/ha. This pot is placed in a greenhouse. The herbicidal effect is examined 15 days after the sowing and planting.

### Test Example 22

A pot is filled with soil and onion seeds and weed seeds are sowed. This pot is placed in a greenhouse. When the onion grows 2 to 6 leaves, the surface of the soil and the stem leaves of the weeds are uniformly treated with A-type crystal flumioxazin at a dose of 12.5, 25, 50, or 100 g/ha. The herbicidal effect is examined 15 days after the treatment.

### Test Example 23

A pot is filled with soil, and weed seeds are sowed and garlic bulbs are planted. On the day of sowing and planting, the surface of the soil is uniformly treated with A-type crystal flumioxazin at a dose of 50, 100, 200, or 400 g/ha. This pot is placed in a greenhouse. The herbicidal effect of the A-type crystal flumioxazin is examined 15 days after the sowing and planting.

### Test Example 24

A pot is filled with soil and sunflower seeds and weed seeds are sowed. This pot is placed in a greenhouse. When the sunflower grows 2 to 6 leaves, the surface of the soil and the stem leaves of the weeds are uniformly treated with A-type crystal flumioxazin at a dose of 12.5, 25, 50, or 100 g/ha. The herbicidal effect of the A-type crystal flumioxazin is examined 15 days after the treatment.

### Test Example 25

A pot is filled with soil and wheat seeds and weed seeds are sowed. This pot is placed in a greenhouse. When the wheat grows 2 to 6 leaves, the surface of the soil and the stem leaves of the weeds are uniformly treated with A-type crystal flumioxazin at a dose of 12.5, 25, 50, or 100 g/ha. The herbicidal effect of the A-type crystal flumioxazin is examined 15 days after the treatment.

### Test Example 26

The surface of soil in a cultivated field where grape, Citrus unshiu, peach, and almond are cultivated is uniformly treated with A-type crystal flumioxazin at a dose of 1, 5, 10, 50, 100, 150, 500, 750, or 1000 g/ha. The herbicidal effect of the A-type crystal flumioxazin is examined 28 days after the treatment.

According to the present invention, a wide range of weeds can be controlled in a crop field, land under perennial crops, or a non-crop land.

What is claimed is:

1. A method of controlling weeds in a crop fields, land under perennial crops, or a non-crop land, the method comprising applying an effective amount of crystal of flumioxazin which shows a powder X-Ray diffraction pattern having diffraction peaks with 2θ values (°) shown in Table 1,
said pattern being obtained by CuKα rays diffraction analysis,
TABLE 1
2θ value (°)
9.8 ± 0.1
11.4 ± 0.1
12.7 ± 0.1
13.8 ± 0.1
16.0 ± 0.1
16.4 ± 0.1
16.7 ± 0.1
to soil where the weeds are grown or to be grown, or weeds.

2. The method according to claim 1, wherein the crop field is a field for soybean, peanut, common bean, pea, corn, cotton, wheat, rice, sunflower, potato, sugar cane, or vegetable.
